(19) United States
(12) Patent Application Publication
(10) Pub. No.: US 2017/0161354 A1
(43) Pub. Date: Jun. 8, 2017

(54) CHART CONVERSION SYSTEM AND METHOD USING METADATA

(71) Applicant: GREENCAT SOFTWARE CO., LTD., Anyang-si, Gyeonggi-do (KR)

(72) Inventor: Gi Tae CHO, Seoul (KR)

(21) Appl. No.: 14/786,154

(22) PCT Filed: Mar. 11, 2015
(86) PCT No.: PCT/KR2015/002336

§ 371 Date: Oct. 21, 2015

(30) Foreign Application Priority Data
Aug. 28, 2014 (KR) 10-2014-0112930

(51) Int. Cl. G06F 17/30; G06Q 90/00; G06F 17/50; G06T 11/20; G06F 17/21

(52) U.S. Cl. CPC G06F 17/30595; G06T 11/206; G06F 17/21; G06F 17/30592; G06F 17/50; G06Q 90/00

(57) ABSTRACT

Disclosed is a chart conversion system and method using metadata. The chart conversion system includes: a metadata management module for storing a chart rule that includes chart components for representing a chart, a chart runtime for implementing the chart rule, and chart type information added in the form of metadata; an extraction module for extracting the metadata of the chart type information from the metadata management module; and a control module for calculating the variation of each of the chart components and for combining the calculated variation with the metadata of the chart type information, which is extracted from the extraction module.

### BACKGROUND OF THE INVENTION

Technical Field

The present invention relates to a chart conversion system and method. More particularly, the present invention relates to a system and method for converting any image file based on a vector format into a chart.

Background Art

Recently, as the focus of Internet-based technology is transferred from a server to a web browser, standards related to graphics technology, such as a Canvas Application Programming Interface (API) and Scalable Vector Graphics (SVG), are actively used. More and more web applications in which complex visual interactions are emphasized are constructed using graphics technology.

Among these graphics-related technologies, SVG supports authoring tools that are widely used by graphic designers, and enables the dynamic control of individual components using Javascript, which is a major language for development based on web browsers. Therefore, SVG is the preferred format for visualizing data for dashboards or charts over the web.

Korean Patent Application Publication No. 10-2007-7015384 and others disclose a method for displaying information on a graphical user interface and the like, but in the conventional arts, converting an SVG file, which is created by a designer using an authoring tool, into a dynamic component on the web, such as a dashboard, a chart, and the like, involves a Javascript developer. Furthermore, as the design is more complex and the level of visualization is higher, closer collaboration between the designer and the developer is required.

However, for such collaboration, the designer must understand the requirements of the developer, and the developer must understand the SVG standard as well as Javascript.

It is uncommon for a designer to directly handle the content of an SVG file or for a developer to be intimately involved in design work. On account thereof, in spite of rapid advances in web-based visualization technology, the designs used in dashboards and charts have not departed from simple and standard patterns.

### DISCLOSURE

### Technical Problem

The present invention is proposed to solve the above-mentioned problems, which may occur in the process of creating components for visualizing data, such as a dashboard, a chart, and the like, by combining a script with a graphics file based on a vector format such as SVG.

An object of the present invention is to clearly separate the role of a designer from the role of a developer by adding metadata to a design file according to a predetermined rule, thus improving work efficiency of the developer and designer.

Also, another object of the present invention is to enable graphic designers to add metadata to their work output, either directly or using a separate application, to complete a chart or dashboard having visualized data without the help of a developer, whereby high-quality content may be quickly produced.

Also, a further object of the present invention is to increase code reusability and to maximize development efficiency by applying identical code to various designs by enabling developers to construct data visualization components or platforms based on a rule generalized for metadata regardless of the distinct characteristics of individual design content.

The object of the present invention is not limited to the above-mentioned objects, and other unmentioned objects may be understood from the following descriptions by those skilled in the art.

### Technical Solution

To achieve the above objects, a chart conversion system according to an aspect of the present invention includes a metadata management module for storing a chart rule that includes chart components for representing a chart, a chart runtime for implementing the chart rule, and chart type information added in a form of metadata; an extraction module for extracting metadata of the chart type information from the metadata management module; and a control module for calculating a variation of each of the chart components and for combining the calculated variation with the metadata of the chart type information, extracted from the extraction module.

In a preferred embodiment, the metadata management module includes a chart storage unit for storing the chart rule including the chart components, the chart runtime, the chart type information added in the form of metadata, a Document Object Model (DOM) including the chart, and a DOM object; a match unit for providing at least one DOM object corresponding to an uploaded graphics file when the graphics file based on a vector format is uploaded by a design file creator, and for matching the provided DOM object with the graphics file; and a generation unit for adding metadata in the DOM object, according to a result of the match.

In a preferred embodiment, the chart storage unit is configured to store the DOM object in which the metadata is added.

A chart conversion method according to another aspect of the present invention includes displaying a screen for selecting a chart for an uploaded design file when the design file is uploaded; connecting essential components of the chart to a design component included in the design file; and storing information about the components of the chart as metadata in the design file, the components of the chart being connected to the design component.

The chart conversion method further includes extracting metadata of the components of the chart; selecting a runtime for a type of the chart; determining the components of the chart based on the selected runtime; calculating a variation of each of the determined components of the chart; combining the calculated variation of the components of the chart with the extracted metadata of the components of the chart; and displaying the combined chart.

### Advantageous Effect

As described above, according to the present invention, misunderstanding in the communication process and delay factors, attributable to the differences in experience and background knowledge between a graphic designer and a script developer, may be prevented by minimizing the necessity for direct collaboration between the designer and the developer when developing dynamic components for data visualization.

Also, using the above-mentioned characteristic of the present invention, many unspecified designers may quickly produce a desired chart or dashboard using a previously implemented runtime service, without an additional development process. Accordingly, the present invention may also be used for a marketplace service for reusable data visualization components.

Because data visualization content may be quickly created using the present invention, it is possible to construct an infographic production service based on data visualization content and a dashboard service that supports various themes and templates.

### BRIEF DESCRIPTION OF THE DRAWINGS

FIG. 1 is a view illustrating the configuration of a data visualization system according to an embodiment of the present invention;

FIG. 2 is a block diagram illustrating the configuration of a data visualization device according to an embodiment of the present invention;

FIG. 3 is a view in which the configuration of a data visualization device according to an embodiment of the present invention is described in detail;

FIG. 4A is a flowchart illustrating the flow of a chart conversion method according to an embodiment of the present invention;

FIG. 4B is a view in which a process for uploading an original design file to a chart storage unit 210 and for converting the uploaded file into a chart component, according to the flow of FIG. 4A, is illustrated to help understanding;

FIG. 5A is a flowchart illustrating a process in which a chart runtime, implemented according to an embodiment of the present invention, extracts metadata from a chart component and displays a dynamic chart by combining data with the metadata;

FIG. 5B is a view in which the flow of FIG. 5A is applied to a bar chart;

FIG. 6 is a view illustrating an example of the configuration of a computer device according to an embodiment of the present invention, in which a data visualization method according to an embodiment of the present invention may be implemented; and

FIG. 7 is a view illustrating a dial chart according to an embodiment of the present invention.

### PREFERRED EMBODIMENTS OF THE INVENTION

The present invention relates to a system and method for automatically converting any image file in a vector format into a dynamic chart by adding metadata to the image file. Specifically, the present invention provides a chart conversion system and method using metadata, in which components for visualizing data, such as a dashboard, a chart, and the like, are generated by combining a script with a graphics file based on a vector format.

The present invention provides a module capable of changing metadata and adding metadata to any design file in a vector format, the module being provided as a web application program or a plug-in for a design authoring tool. Also, the present invention provides an intuitive user interface for writing metadata for supporting a predefined chart type or dashboard type.

Meanwhile, the present invention provides a runtime environment in which a design file can be operated as a complete form of chart or dashboard according to data retrieved from an original data file, by combining the design file to which the metadata has been added with an object that implements a rule for the defined chart type or dashboard type.

The advantages and features of the present invention and methods of achieving them will be apparent from the following exemplary embodiments that will be described in more detail with reference to the accompanying drawings. It should be noted, however, that the present invention is not limited to the following exemplary embodiments, and may be implemented in various forms. Accordingly, the exemplary embodiments are provided only to disclose the present invention and let those skilled in the art know the category of the present invention. It will be further understood that the terms are only used to describe embodiments and not to limit the scope of claims. Herein, the singular forms are intended to include the plural forms as well, unless the context clearly indicates otherwise.

Hereinbelow, exemplary embodiments of the present invention will be described in detail with reference to the accompanying drawings. As for reference numerals associated with parts in the drawings, the same reference numerals will refer to the same or like parts throughout the drawings. Hereinbelow, in the description, details of well-known features and techniques may be omitted to avoid unnecessarily obscuring the presented embodiments.

Before the description, the meaning of terminology used herein is simply described. It should be understood that the terminology used herein is for the purpose of helping the understanding of this specification and is not intended to limit the scope and sprit of the invention unless expressly so defined herein.

### Metadata

Generally, ‘metadata’ may be defined as ‘data about data’. That is, metadata is ‘structured data for data’, meaning that it is attribute information for describing other data. Metadata is assigned to content according to a certain rule so that desired information can be effectively searched for among a huge amount of information.

In this specification, metadata is understood as reference information about graphics components, including metadata tags and class attributes, or about entire documents in the context of Scalable Vector Graphics (SVG) documents.

### Graphic Based on a Vector Format

Exemplified by Scalable Vector Graphics (SVG), Adobe Illustrator (AI), and Encapsulated PostScript (EPS), it means a format for storing image data, which is freely scaled to any magnification by storing geometric structure information and attributes rather than RGB values for each pixel in a picture.

### Scalable Vector Graphics (SVG)

SVG is a file format based on eXtensible Markup Language (XML) for representing two-dimensional vector graphics, and is a vector graphics file format. Because SVG images and operations concerning the images are defined in XML text files, they may be retrieved, indexed, and scripted, and may be compressed if necessary. Also, because the SVG format is standard technology that is widely supported by browsers, it is commonly used to implement a dynamic data visualization function on the web.

All examples of this specification are to be regarded as being based on SVG unless otherwise stated. However, because the concept of the present invention may be applied to all vector graphics formats to which metadata may be added and which have structural components capable of being accessed by a program, the present invention should not be interpreted as being necessarily applied only to the SVG format, and implementation using SVG is to be regarded only as an embodiment of the present invention.

Meanwhile, because an SVG file is configured in the form of XML, structural operations are easily performed using the DOM API. Also, an SVG document generally includes special metadata tags for enabling producers to specify copyright, etc. as well as design components such as figures, colors, and the like. Also, most of the components of an SVG document may be defined using class attributes, like in HTML.

eXtensible Markup Language (XML)

A markup language is a language specifying data structures using tags, and XML is made by largely improving HyperText Markup Language (HTML), which is used for creating Internet web pages. Compared to HTML, XML has improved functions for constructing and searching web pages, and facilitates the creation and authoring of web pages.

FIG. 1 is a view illustrating the configuration of a data visualization system according to an embodiment of the present invention.

Referring to FIG. 1, an embodiment is illustrated in which many unspecified designers A and B and a small number of developers C respectively perform design work and system management without direct cooperation between them, using a data visualization system having a chart storage unit 210 and a chart runtime.

In the embodiment, multiple pieces of reusable chart content have been stored in advance in the chart storage unit 210. A chart user D may write a report in which chart data is visualized using the chart content previously stored in the chart storage unit 210.

In this case, the chart content, previously stored in the chart storage unit 210, includes a chart rule and a chart runtime. Here, the chart rule is a certain set of rules that are abstractly defined in order to represent a chart from given data according to the chart type, such as a bar chart, a pie chart, and the like.

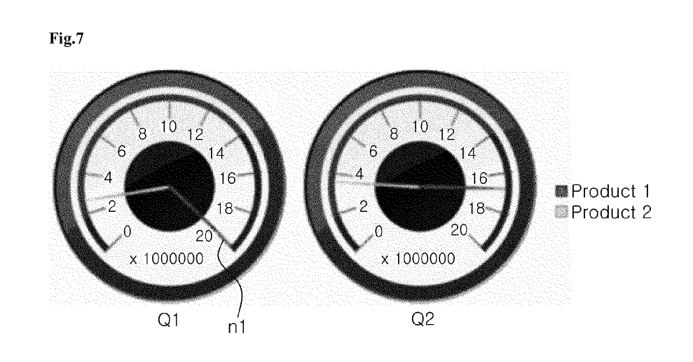

For example, if the chart is a dial chart, the chart rule may include design components of the dial chart. Here, the dial chart is a chart for indicating one or more values using a needle that points to graduations in a circular array, as illustrated in FIG. 7.

In other words, in the design of various dial charts, components corresponding to at least one needle n1 are necessarily included in order to represent the value of current data. Additionally, the design of the dial charts includes content indicating that the needle n1 should turn clockwise based on a certain point 10 by angles corresponding to a percentage of the current value to the maximum value of data.

The chart runtime is an object that implements the chart rule in practice, and acquires references for the components including the above-mentioned needle of the dial chart, etc., through a Document Object Model Application Program Interface (DOM API). Subsequently, the chart runtime calculates the new position or size of the component from associated data and applies the calculated value to the chart. In the embodiment, the corresponding operations may be performed through a transformation API in the case of SVG.

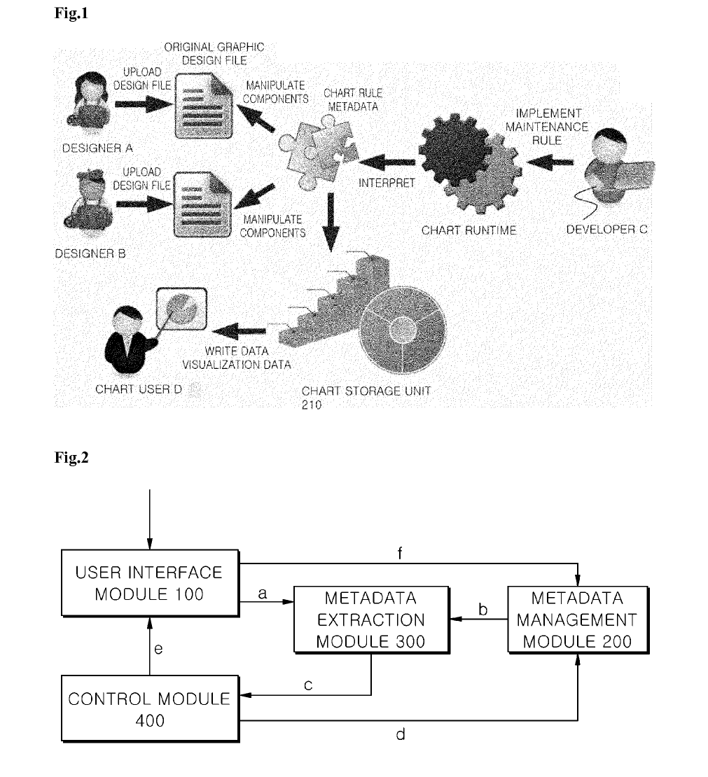

FIG. 2 is a block diagram illustrating the configuration of a data visualization device according to an embodiment of the present invention.

Referring to FIG. 2, a data visualization device for automatically converting an image file into a dynamic chart by adding metadata in any image file based on a vector format includes a user interface module 100, a metadata management module 200, a metadata extraction module 300, and a control module 400.

The term ‘module’ used herein should be interpreted as including software, hardware, or a combination thereof, according to the context in which the term is used. For example, software may be machine code, firmware, embedded code, or application software. As another example, hardware may be a circuit, a processor, a computer, an integrated circuit, an integrated circuit core, a sensor, a Micro-Electro-Mechanical System (MEMS), a passive device, or a combination thereof.

The user interface module 100 provides an input/output interface to users including a designer, a developer, and a chart user. For example, the user interface module 10 provides a designer with an interface for uploading a graphics file and an interface for matching chart components with a design graphics file. As another example, the user interface module 100 provides a developer with an interface for extracting metadata from a graphics file, to which metadata has been added by a designer, and an interface for displaying a chart converted via a chart conversion process.

The metadata management module 200 stores a chart rule that includes chart components for displaying a chart and a chart runtime for implementing the chart rule.

The metadata extraction module 300 extracts metadata (b) about a chart component corresponding to image file data (a), which is input from the metadata management module 200 to the user interface module 100.

The control module 400 calculates a variation of each of the chart components, and receives metadata (c) extracted from the metadata extraction module 300. The calculated variation of each of the chart components and the extracted metadata are combined by the control module 400. Then, the control module 400 delivers the combined chart component data (e) to the user interface module 100 to be output to a user.

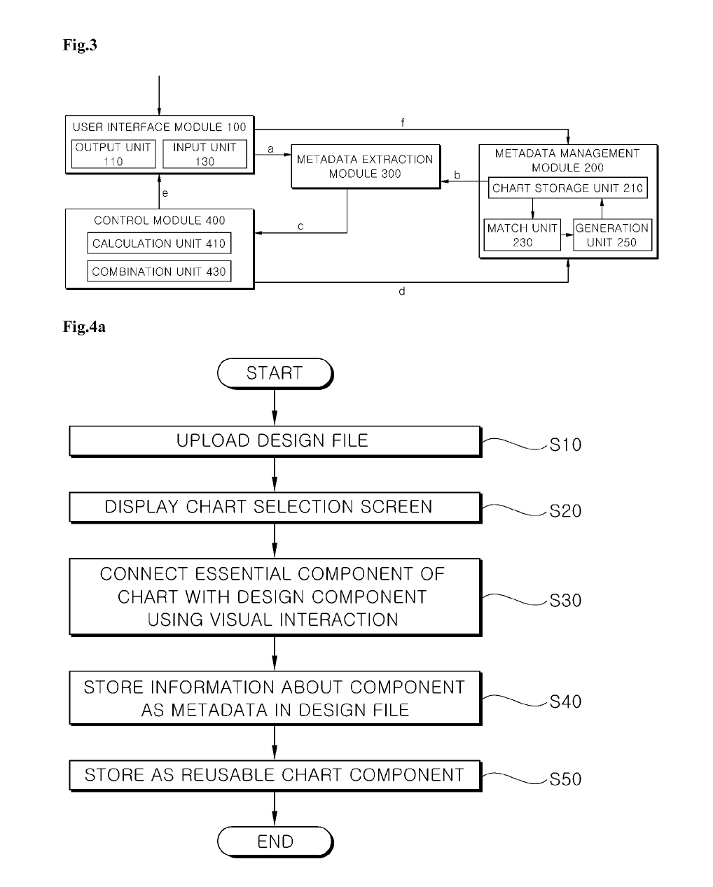

FIG. 3 is a view in which the configuration of a data visualization device according to an embodiment of the present invention is described in detail.

Referring to FIG. 3, the user interface module 100 of the data visualization device includes an input unit 110 and an output unit 130, the metadata management module 200 includes a chart storage unit 210, a match unit 230, and a generation unit 250, and the control module 400 includes a calculation unit 410 and a combination unit 420. In the description of FIG. 3, repeated descriptions will be omitted.

The chart storage unit 210 of the metadata management module 200 stores a chart runtime, a chart rule including chart components, and chart type information, which is added in the form of metadata.

When a graphics file in a vector format (f) is uploaded by a design file creator, the match unit 230 provides at least one Document Object Model (DOM) object corresponding to the graphics file uploaded from the chart storage unit 210, and matches the provided DOM object with the graphics file.

The generation unit 250 adds metadata to the DOM object according to the result of the match, whereby chart type information to which metadata is added is generated.

The chart type information including the metadata, generated by the generation unit 250, may be delivered to the chart storage unit 210 and be stored therein.

A chart conversion method according to another aspect of the present invention includes a step in which a screen for selecting a chart for an uploaded design file is displayed when the design file is uploaded by a graphics file creator or a designer, a step for connecting the essential components of the chart with design components included in the design file, and a step for storing information about the chart components connected with the design components as metadata in the design file.

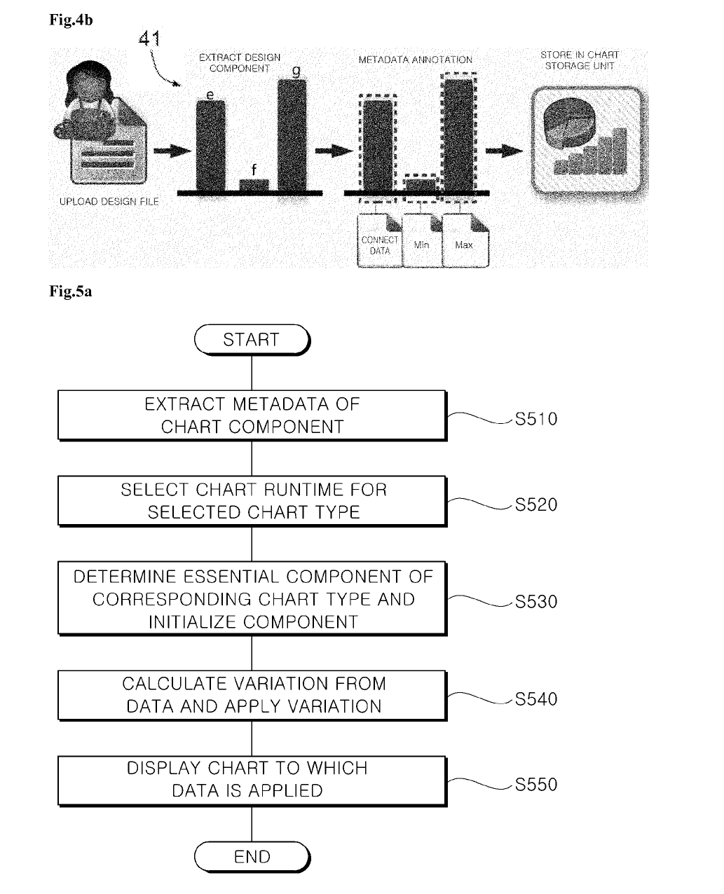

FIG. 4A is a flowchart illustrating the flow of a chart conversion method according to an embodiment of the present invention. Specifically, FIG. 4A shows a process in which an original design file is uploaded to the chart storage unit 210 and is converted into a chart component. The process in which metadata is set for a graphic design, produced by a designer, using a chart conversion method according to an embodiment of the present invention is described with reference to FIG. 4A. The following process for adding the metadata may be implemented as a plug-in of a design authoring tool, and the process illustrated in FIG. 4A should be interpreted as a representative embodiment of the present invention.

First, a process for uploading an original design file to a chart storage unit 210 configured according to an embodiment is performed at step S10. In this case, a designer saves a graphic design file, produced through an authoring tool, in an SVG format, and uploads the file to the chart storage unit 210 of the data visualization device. Accordingly, at step S20, a screen for selecting a chart corresponding to the uploaded original design file is displayed. In this case, the chart storage unit 210 lists the types of charts supported by a system, whereby the designer may select the target into which the uploaded design file is to be converted.

At step S30, a chart component and a design component are connected to each other through visual interaction. Then, at step S40, information about the chart component is stored as metadata in the design file.

For example, if a designer selects a dial chart at step S20, the chart conversion system displays the uploaded design file at steps subsequent to step S20 and provides the designer with references for SVG DOM objects corresponding to a needle, an axis, and the like, which are the essential components of the dial chart. Accordingly, a class attribute such as ‘class=“indicator”’ may be added through a DOM API, whereby it is possible to write content indicating that the relevant object should function as the needle of the dial chart at run time.

After metadata for the essential components of the chart are written by the above-described method, the data visualization system adds information about the selected chart type as metadata, such as ‘<chart:type>dial</chart:type>’, to the file according to a predetermined method, using the extension of custom namespaces of XML in the ‘metadata’ tag in the SVG file, and then saves the file at step S50.

FIG. 4B is a view in which a process for uploading an original design file to a chart storage unit 210 and for converting the uploaded file into a chart component, according to the flow of FIG. 4A, is illustrated to help understanding.

For the bar chart 41 illustrated in FIG. 4B, an embodiment of the present invention additionally establishes bar components having lengths corresponding to the minimum and maximum values of the chart, besides the bar components e, f, and g, associated with data of the chart storage unit 210. The additional components may be represented by designating ‘class’ attributes such as ‘class=“min”’ and ‘class=“max”’ to a corresponding SVG tag, as in the above-mentioned method.

FIG. 5A is a flowchart illustrating the process in which a chart runtime, implemented according to an embodiment of the present invention, extracts metadata from a chart component and displays a dynamic chart by combining data with the metadata.

When a request for a chart component for an attached report is received, a process for extracting metadata, added to the relevant chart component, is performed at step S510. Then, the chart type is checked according to the extracted metadata and a chart runtime supporting the chart type is executed at step S520.

After the execution of the chart runtime, a process for determining essential components of the corresponding chart type is performed at step S530. For example, in the case of a dial chart, the chart runtime retrieves the component corresponding to the needle of the dial by checking whether a ‘class’ attribute having the value ‘indicator’ exists in the SVG file of the corresponding chart component. This process may be performed using the DOM API or a Javascript library based on the DOM API.

After the references for DOM objects of the needle and axis are acquired through the above-mentioned method, the variation of the component is calculated from data associated with the chart, and is applied to the chart at step S540. For example, according to the chart type, if the chart is a dial chart, the rotation angle of the needle, which is a component of the chart, is calculated. Because a dial chart generally shows a percentage to a maximum value, the ratio of the rotation angle of the needle to 360 degrees, corresponding to the maximum rotation angle, may be represented as a percentage.

At step S550, the chart, to which the variation is applied by applying the calculated angle to the object through a transformation API, is displayed. In the above-described embodiment, when the variation is applied to the needle object of the dial chart and thus the needle object turns based on the axis object, a complete dial chart to which the value of data is applied operates.

Meanwhile, according to the design of a dial chart, there may be the case in which the range of the rotation angle of the needle is limited to a specific range, for example, from −120 degrees to 120 degrees, rather than 360 degrees. In this case, the specific range is written using a ‘metadata’ tag in the SVG document as described above, and the range may be referred to by being extracted by the chart runtime when calculation is performed.

According to an embodiment of the present invention, the chart component may be used for data visualization by being added to a report or a dashboard used by an end user, according to need. In this case, the chart runtime may be configured to display a complete chart, generated by combining data provided by the end user with the chart component, which includes the metadata and is imported from the chart storage unit 210.

FIG. 5B is a view in which the flow of FIG. 5A is applied to a bar chart.

As illustrated in FIG. 5B, in an embodiment, metadata for a chart component is extracted, components corresponding to maximum and minimum values are retrieved, and the size of the area that can be occupied by a bar is calculated based on the screen boundaries of the components. Then, the data component is copied in a number corresponding to the number of data items to be plotted (‘A’, ‘B’, ‘C’, and ‘D’ in the embodiment illustrated in FIG. 5), and the length of each of the bars is calculated based on the percentage of the value of the data item to the calculated area, and is applied to the chart through a transformation API.

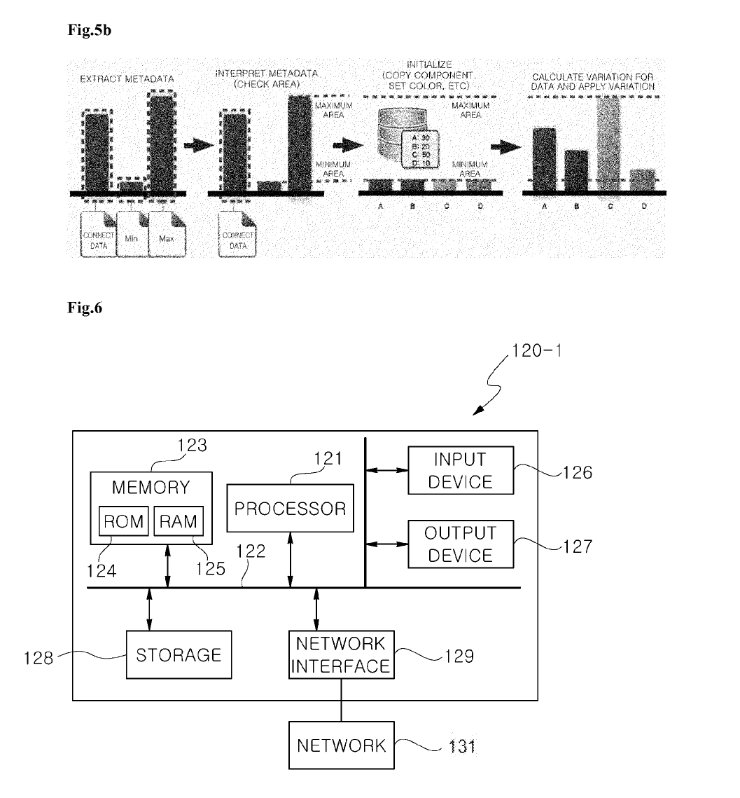

FIG. 6 is a view illustrating an example of the configuration of a computer device according to an embodiment of the present invention, in which a data visualization method according to an embodiment of the present invention may be implemented.

A chart conversion method according to an embodiment of the present invention may be implemented in a computer system, or may be recorded in a recording medium. As illustrated in FIG. 6, the computer system may include at least one processor 121, memory 123, a user input device 126, a data communication bus 126, a user output device 127, and storage 128. Each of these components performs data communication through the data communication bus 122.

The computer system may further include a network interface, coupled to a network. The processor 121 may be a Central Processing Unit (CPU), or a semiconductor device for processing instructions stored in the memory 123 and/or the storage 128.

The memory 123 and the storage 128 may include various types of volatile or non-volatile storage media. For example, the memory 123 may include ROM 124 and RAM 125.

Accordingly, the chart conversion method according to an embodiment of the present invention may be implemented as a method executable in the computer. When the chart conversion method according to an embodiment of the present invention is implemented in the computer device, computer-readable instructions may implement the chart conversion method according to the present invention.

Meanwhile, the above-described chart conversion method according to an embodiment of the present invention may be implemented as computer-readable code recorded on a computer-readable storage medium. The computer-readable storage medium includes all kinds of storage media in which data that can be interpreted by a computer system are stored. For example, the computer-readable storage medium may include Read Only Memory (ROM), Random Access Memory (RAM), a magnetic tape, a magnetic disk, flash memory, optical data storage, and the like. Also, the computer-readable storage medium may be distributed in a computer system connected by a computer network, and may be stored and executed as code that can be read using a distributed method.

While the present invention has been described in connection with the preferred embodiments and accompanying drawings, they are merely illustrative. It is to be understood that various equivalent modifications and variations of the embodiments can be made in the art without departing from the spirit and scope of the present invention. Therefore, the true technical scope of the present invention should not be defined by the above-mentioned embodiments but should be defined by the appended claims and equivalents thereof.

### INDUSTRIAL APPLICABILITY

The present invention may be used in a graphic design field.

1. A chart conversion system for visualizing chart data, comprising:
a metadata management module for storing a chart rule that includes chart components for representing a chart, a chart runtime for implementing the chart rule, and chart type information added in a form of metadata;
an extraction module for extracting metadata of the chart type information from the metadata management module; and
a control module for calculating a variation of each of the chart components and for combining the calculated variation with the metadata of the chart type information, extracted from the extraction module.

2. The chart conversion system of claim 1, wherein the metadata management module comprises:
a chart storage unit for storing the chart rule including the chart components, the chart runtime, the chart type information added in the form of metadata, a Document Object Model (DOM) including the chart, and a DOM object;
a match unit for providing at least one DOM object corresponding to an uploaded graphics file when the graphics file based on a vector format is uploaded by a design file creator, and for matching the provided DOM object(s) with the graphics file; and
a generation unit for adding metadata in the DOM object(s), according to a result of the match.

3. The chart conversion system of claim 2, wherein the chart storage unit is configured to store the DOM object(s) in which the metadata is added.

4. A chart conversion method, comprising:
when a design file is uploaded, displaying a screen for selecting a chart for the uploaded design file;
connecting essential components of the chart to a design component included in the design file; and
storing information about the components of the chart as metadata in the design file, the components of the chart being connected to the design component.

5. The chart conversion method of claim 4, further comprising:
extracting metadata of the components of the chart;
selecting a runtime for a type of the chart;
determining the components of the chart based on the selected runtime;
calculating a variation of each of the determined components of the chart;
combining the calculated variation of the components of the chart with the extracted metadata of the components of the chart; and
displaying the combined chart.
